(19) United States
(12) Patent Application Publication
(10) Pub. No.: US 2007/0132353 A1
(43) Pub. Date: Jun. 14, 2007

(54) Vortex cooled lamp

(76) Inventors: Jeroen Gijzen, Eindhoven (NL); Paul B. J. Schaareman, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/578,204

(22) PCT Filed: Nov. 4, 2004
(86) PCT No.: PCT/IB04/52308

§ 371 Date: May 4, 2006

Related U.S. Application Data
(60) Provisional application No. 60/518,522, filed on Nov. 6, 2003.

(51) Int. Cl. H01K 1/26

(52) U.S. Cl. 313/113

(57) ABSTRACT

A lamp assembly (301) includes a reflector (306) having an opening (334) defined by an upper rim (333) and a concave reflective surface (336) surrounded by the upper rim (333), and an illumination element (304) is mounted within the opening (334) of the reflector (306). An air guide conduit (335) extends around the upper rim (333) of the reflector (306 ). The air guide conduit (335) has an air inlet (336a, 336b) connected to a blower (320a, 320b) and an air outlet (337 ) into the opening (334) of the reflector (306). In operation, the blower (320a, 320b) and air guide conduit (335) cooperate to introduce a vortex tangentially into the opening (334) such that the vortex travels down the concave reflective surface (336) of the reflector, thereby cooling the lamp assembly (301).

This invention pertains to the field of illumination lamps, and more particularly, to the cooling of illumination lamps that may be used, for example, in projection display systems.

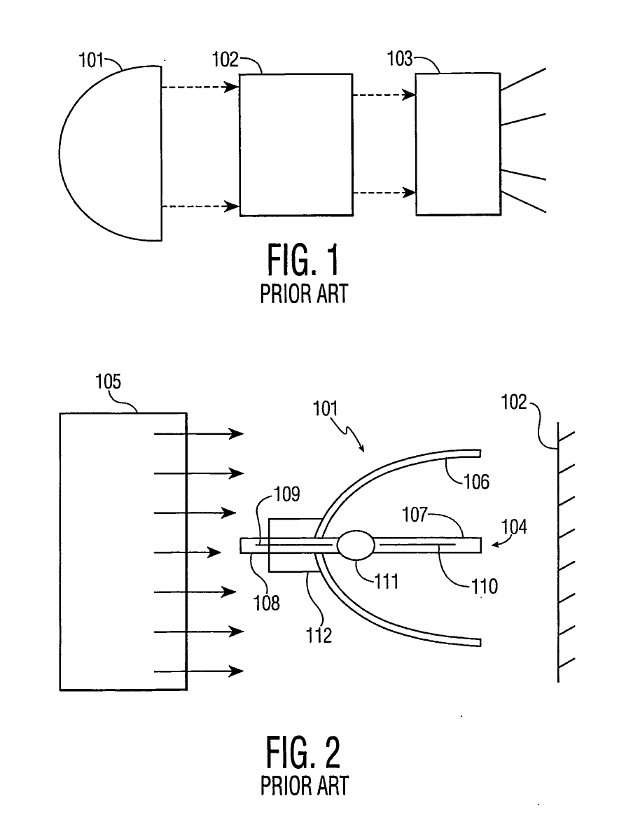

The main component parts of a projection display system are schematically illustrated in FIG. 1. As shown, light from an illumination source or lamp 101 is directed into a modulator 102. The modulator 102 may include, for example, polarizers for polarizing the light, liquid crystal display (LCD) panels for encoding the light, and beam splitters for decoding the encoded light into an intensity image. The intensity image from the modulator 102 is then supplied to a projection lens assembly 103 for visual display.

Referring to FIG. 2, the lamp 101 is generally configured of a bulb assembly 104 coaxially mounted in an elliptical or parabolic reflector 106. The bulb assembly 104 includes a back-end foil 109 sealed within a quartz rod 108, and a front-end foil 110 sealed within another quartz rod 107. The foils 109 and 110 function as anode/cathode electrodes and are typically formed of molybdenum (Mo). A bulb 111 is fixed between the quartz rods 107 and 108, and is contained within the elliptical or parabolic region defined by reflector 106. Reference number 112 of FIG. 2 denotes a neck of the reflector 106 which is used to achieve stable and secure mounting of the bulb assembly 104.

To obtain the necessary illumination power for the projection system, the bulb 111 of the lamp 101 is a high-wattage bulb (e.g., 200 watts) which inherently exhibits substantial heat emissions. In the absence of some sort of heat-dissipating device, the heat from the bulb can constitute a safety hazard and a source of component failure in the light modulator 102. Accordingly, in an effort to dissipate heat generated by the lamp 101, a blower or fan 105 is placed in the vicinity of the lamp 101. The cooling air from the fan 105 is incident on the outside of the reflector 106 and thereby achieves some cooling of the lamp 101.

Unfortunately, the cooling characteristics of the conventional arrangement are highly inefficient, and accordingly, a relatively powerful fan 105 must be used to achieve suitable cooling of the lamp 101. The fan 105 therefore tends to be quite loud, which results a noisy projection display system.

In an effort to improve cooling efficiency, one conventional technique includes directing air from a blower through an aperture in the reflector directly onto the bulb. However, this can cause serious thermal gradients over the bulb's circumference since the one side of the bulb facing the aperture is cooled better than the other side of the bulb. If the “cool” side becomes to “cold”, this could lead to local condensation of the vapor (Mercury) inside the bulb. Local condensation of the vapor can make the bulb quartz wall opaque, after which due to light absorption the local bulb temperature increases very quickly causing re-crystalization of the quartz, making it further opaque and less transmissive. This phenomenon, known as “blackening”, reduces the lamp performance and life time.

Accordingly, it would be desirable make more efficient use of available air when cooling the lamp of a projection display system. This would allow for the use of a less powerful fan or blower, which in turn would lower the fan noise, thus providing a more silent projection system. It would also be desirable to make more efficient use of available air when cooling the lamp without causing blackening of the lamp.

According to one aspect of the present invention, a lamp assembly is provided which includes a reflector having an opening defmed by an upper rim and a concave reflective surface surrounded by the upper rim, an illumination element mounted within the opening of the reflector, and an air guide conduit extending around the upper rim of the reflector. The air guide conduit has an air inlet operatively connected to a blower, and an air outlet into the opening of the reflector.

According to another aspect of the present invention, a lamp assembly is provided which includes a reflector having an opening defined by an upper rim and a concave reflective surface surrounded by the upper rim, an illumination element mounted within the opening of the reflector, and a cooling device for introducing a vortex tangentially into the opening such that the vortex travels down the concave reflective surface of the reflector.

According to still another aspect of the present invention, a method of cooling a lamp is provided, where the lamp includes a reflector having an opening defmed by an upper rim and a concave reflective surface surrounded by the upper rim, and an illumination element mounted within the opening of the reflector. The lamp is cooled by introducing a vortex tangentially into the opening such that the vortex travels down the concave reflective surface of the reflector.

In each aspect of the invention, the concave reflective surface may define a parabolic or elliptical opening in the reflector, and the opening in the reflector may face towards an optical modulator of a projection display assembly.

FIG. 1 shows a schematic representation of a conventional projection display system;

FIG. 2 shows a cooling arrangement of the lamp of a conventional projection display system; and

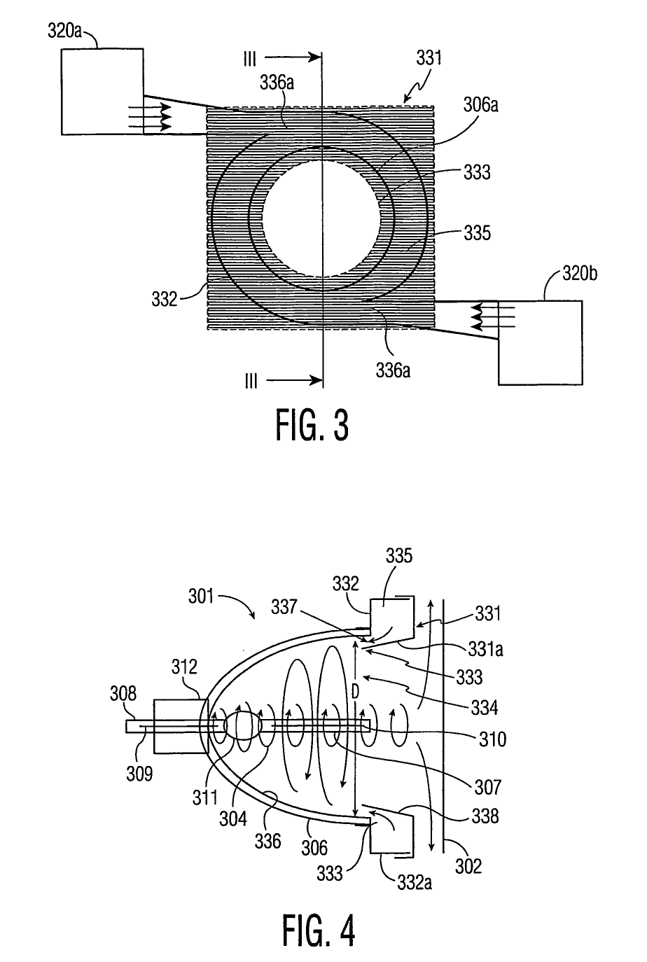

FIGS. 3 and 4 illustrate the cooling arrangement of a lamp of an embodiment of the present invention, in which FIG. 4 is a cross-sectional view taken along line III-III of FIG. 3.

While preferred embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

Reference is now made to FIGS. 3 and 4, which illustrate a vortex cooled lamp according to an embodiment of the present invention. FIG. 4 is a cross-sectional view taken along line III-III of FIG. 3.

The vortex cooled lamp 301 of this embodiment includes a bulb assembly 304 coaxially mounted in an elliptical or parabolic reflector 306. The bulb assembly 304 includes a back-end foil 309 sealed within a quartz rod 308, and a front-end foil 310 sealed within another quartz rod 307. The foils 309 and 310 function as anode/cathode electrodes and are typically formed of molybdenum (Mo). A bulb 311 is fixed between the quartz rods 307 and 308, and is contained within the elliptical or parabolic opening 334 defined by an upper rim 333 and a concave reflective surface 336 of the reflector 306. Reference number 312 of FIG. 4 denotes a neck of the reflector 306 which is used to achieve stable and secure mounting of the bulb assembly 304.

The vortex cooled lamp 301 further includes an air guide conduit 335 extending around the upper rim 333 of the reflector 306. The air guide conduit 335 includes one or more air inlets 336a, 336b operatively connected to one or more blowers 320a, 320b, and an air outlet 337 into the opening 334 of the reflector 306.

As shown in FIGS.3 and 4, the air guide conduit 335 of this embodiment circumferentially overlaps the opening 334 in the reflector 306, and the air outlet 337 is located at the circumferential overlap between the air guide conduit 335 and the opening in the reflector 306. The air outlet 337 of the air guide conduit 335 is adjacent an inner periphery of the upper rim 333 of the reflector 306, and extends circumferentially adjacent the inner periphery of the upper rim 333 of the reflector 306. More particularly, in this embodiment, the air guide conduit 335 includes an inner side wall 338 extending adjacent to and spaced from the inner periphery of the upper rim 333 of the reflector 306, and the air outlet 337 is defined between the upper rim 333 of the reflector 306 and the inner side wall 338 of the air guide conduit 335.

Also, as shown in FIGS. 3 and 4, the air guide conduit 335 of this embodiment is defined by an outer collar 332 and a front cap collar 331. An inner rim 333 of the front cap collar 331 is coaxially positioned within the inner diameter 306a (FIG. 3) of the reflector 306. An outer wall 332a of the outer collar 332 extends circumferentially around an outer periphery of the upper rim 333 of the reflector 306, and an inner side wall 33 la of the front cap collar 331 extends circumferentially within an inner periphery of the upper rim 333 of the reflector 306. The inner side wall 331a of the front cap collar 331 partially extends into the opening 334 and is spaced from the inner periphery of the upper rim 333 to define the air outlet 337 there between.

When used in a projection display device, the opening 334 in the reflector 306 faces towards an optical modulator 302 of the projection display device.

In operation, cooling air from the blowers 320a and 320b is tangentially introduced into the air guide conduit 335 located in front of the opening 334 of the reflector 306. This then causes a whirl (vortex) in the air guide conduit 335, which enters the reflector 306 through the opening 337. Next, the vortex travels towards the reflector neck 312 along the inside reflective surface 336 of the reflector 306. As the diameter D of the reflector 306 decreases towards the reflector neck 312, conservation of momentum causes the velocity of the vortex to increase. The increasing air velocity causes the net heat transfer (coefficient) around the bulb 311 to also increase, thus increasing cooling efficiency. Also, since the air of the vortex flows around the circumference of the bulb 311, the net heat transfer may further increase. Furthermore, due to the mixing effect of the vortex inside the reflector 306, the heat transfer to the wall of the reflector 306 will also improve.

Next, due to conservation of mass, the vortex (which has now a net smaller diameter and is coaxially contained within the original outer portion of the vortex) will be reflected from the bottom of the reflective surface 336 and travel back to the front end of the reflector 306 along the quartz rod 307 with the front foil 310 embedded therein. Hence, the front foil 310 will also be cooled around its circumference if the local vortex temperature is below that of the quartz rod 310.

Finally, when used in a projection display device, the air will radially exit the assembly after it incidents with the first optical component of the optical modulator 302.

When compared to conventional cooling arrangements, the present invention makes more efficient use of available air when cooling the lamp. This allows for the use of a less powerful fan or blower, which in turn lowers the fan noise. Thus, in the case of projection systems, a more silent projection display device can be provided. Also, the risk of blackening of the vortex cooled lamp is substantially reduced since the air flow is “whirling” around the bulb, thus reducing or equalizing the thermal gradient around the circumference. Smaller thermal gradients also lead to less thermal mechanical stresses of the quartz which can increase the life time of the lamp and/or bulb.

While preferred embodiments are disclosed herein, many variations are possible which remain within the concept and scope of the invention. Such variations would become clear to one of ordinary skill in the art after inspection of the specification, drawings and claims herein. As one example only, it is possible to introduce a vortex into the reflector opening by directing air tangentially into the opening without the aid of an air guide conduit. The invention therefore is not to be restricted except within the spirit and scope of the appended claims.

1. A lamp assembly, comprising:
a reflector having an opening defmed by an upper rim and a concave reflective surface surrounded by the upper rim;
an illumination element mounted within the opening of the reflector;
an air guide conduit extending around the upper rim of the reflector, the air guide conduit having an air inlet and having an air outlet into the opening of the reflector; and
a blower operatively connected to the air inlet of the air guide conduit.

2. The lamp assembly as claimed in claim 1, wherein the air outlet of the air guide conduit is adjacent an inner periphery of the upper rim of the reflector.

3. The lamp assembly as claimed in claim 2, wherein the air outlet extends circumferentially adjacent the inner periphery of the upper rim of the reflector.

4. The lamp assembly as claimed in claim 3, wherein the air guide conduit includes an inner side wall extending adjacent to and spaced from an inner periphery of the upper rim of the reflector, and wherein the air outlet is defined between the upper rim of the reflector and the inner side wall of the air guide conduit.

5. The lamp assembly as claimed in claim 1, wherein the concave reflective surface defines a parabolic or elliptical opening in the reflector.

6. The lamp assembly as claimed in claim 1, wherein the air guide conduit circumferentially overlaps the opening in the reflector.

7. The lamp assembly as claimed in claim 6, wherein the air outlet is located at the circumferential overlap between the air guide conduit and the opening in the reflector.

8. The lamp assembly as claimed in claim 1, wherein the opening in the reflector faces towards an optical modulator of a projection display device.

9. The lamp assembly as claimed in claim 1, wherein the air guide conduit comprises an outer wall extending circumferentially around an outer periphery of the upper rim of the reflector, and an inner side wall extending circumferentially around an inner periphery of the upper rim of the reflector.

10. The lamp assembly as claimed in claim 9, wherein the inner side wall partially extends into the opening and is spaced from the inner periphery of the upper rim to define the air outlet there between.

11. A lamp assembly comprising:
a reflector having an opening defined by an upper rim and a concave reflective surface surrounded by the upper rim;
an illumination element mounted within the opening of the reflector; and
cooling means for introducing a vortex tangentially into the opening such that the vortex travels down the concave reflective surface of the reflector.

12. The lamp assembly according to claim 11, wherein the illumination element is coaxially mounted within the opening of the reflector, and wherein said cooling means introduces the vortex into the opening such that the vortex is reflected from a bottom of the concave reflective surface back towards the upper rim of the reflector.

13. The lamp assembly according to claim 12, wherein said cooling means introduces the vortex into the opening such that the portion of the vortex which is reflected back towards the upper rim is coaxially contained within the portion of the vortex which travels down the concave reflective surface of the reflector.

14. The lamp assembly as claimed in claim 13, wherein the concave reflective surface defines a parabolic or elliptical opening in the reflector.

15. The lamp assembly as claimed in claim 13, wherein the opening in the reflector faces towards an optical modulator of a projection display assembly.

16. A method of cooling a lamp, the lamp including a reflector having an opening defmed by an upper rim and an concave reflective surface surrounded by the upper rim, and an illumination element mounted within the opening of the reflector, said method comprising introducing a vortex tangentially into the opening such that the vortex travels down the concave reflective surface of the reflector.

17. The method according to claim 16, wherein the illumination element is coaxially mounted within the opening of the reflector, and wherein the vortex is reflected from a bottom of the concave reflective surface back towards the upper rim the reflector.

18. The method according to claim 17, wherein the portion of the vortex reflected back towards the upper rim of the reflector is coaxially contained within the portion of the vortex traveling down the concave reflective surface of the reflector.

19. The lamp assembly as claimed in claim 18, wherein the concave reflective surface defines a parabolic or elliptical opening in the reflector.

20. The lamp assembly as claimed in claim 18, wherein the opening in the reflector faces towards an optical modulator of a projection display assembly.
